(19) United States
(12) Patent Application Publication
(10) Pub. No.: US 2012/0321891 A1
(43) Pub. Date: Dec. 20, 2012

(54) MANUFACTURING METHOD OF POROUS SILICA BODY, MANUFACTURING METHOD OF OPTICAL FIBER PREFORM, POROUS SILICA BODY, AND OPTICAL FIBER PREFORM

(75) Inventor: Tomohiro NUNOME, Sakura-shi (JP)

(73) Assignee: FUJIKURA LTD., Tokyo (JP)

(21) Appl. No.: 13/596,816

(22) Filed: Aug. 28, 2012

Related U.S. Application Data
(63) Continuation of application No. PCT/JP2011/054901, filed on Mar. 3, 2011.

(30) Foreign Application Priority Data
Mar. 3, 2010 (JP) 2010-046780

(51) Int. Cl. C03B 37/018; B32B 17/02

(52) U.S. Cl. 428/392; 65/421; 65/397; 428/542.8

(57) ABSTRACT

A manufacturing method for a porous silica body including: a step of arranging a plurality of burners around an optical fiber core rod; and a deposition step of depositing a plurality of soot layers on an outer peripheral surface of the optical fiber core rod by the burners, wherein the deposition step comprises forming each of the plurality of soot layers by one of the burners, and depositing each soot layer to satisfy 0.2≦x≦0.5 and 0.1≦y≦4.0x2−3.8x+1.3 where x (g/cm3) is the average bulk density and y (mm) is the deposition thickness, and so that the maximum value of the bulk density of the soot layers becomes 0.6 g/cm3 or less.

### CROSS REFERENCE TO RELATED APPLICATIONS

This application is a continuation application based on a PCT Patent Application No. PCT/JP2011/054901, filed Mar. 3, 2011, whose priority is claimed on Japanese Patent Application No. 2010-046780 filed Mar. 3, 2010, the entire content of which are hereby incorporated by reference.

### BACKGROUND OF THE INVENTION

1. Field of the Invention

The present invention relates to a manufacturing method of a porous silica body in which a plurality of soot layers are deposited on the outer peripheral surface of an optical fiber core rod, a manufacturing method of an optical fiber preform, a porous silica body, and an optical fiber preform.

2. Description of the Related Art

In the manufacture of an optical fiber perform, a method is generally used that sinters and vitrifies a porous silica body that is manufactured by a soot method such as vapor-phase axial deposition method or outside vapor-deposition method (for example, refer to Japanese Patent No. 3853833 (Patent Documents 1) and Japanese Unexamined Patent Application No. H11-199263 (Patent Document 2)). With the development of FTTH (Fiber to the home) in recent years, there is rising demand for an optical fiber with easy handling and low bending loss. Since a reduction in the manufacturing cost of an optical fiber is also important, attempts have been made heretofore to perform manufacture of an optical fiber with a low bending loss without greatly changing manufacturing methods such as vapor-phase axial deposition method or outside vapor-deposition method.

As a technique for reducing the bending loss of an optical fiber, there is a structure in which the refractive index of the cladding region of the optical fiber is lowered to increase the effective refractive index difference between the core and the cladding when the optical fiber is bent. As an example thereof, Patent Document 1 discloses a refractive index structure that is called a trench-type. In a trench-type optical fiber, a trench portion with a low refractive index is provided on the inner side of the cladding layer that constitutes the outermost periphery of the optical fiber. The refractive index structure of the trench-type optical fiber can be fabricated by combining the conventional vapor-phase axial deposition method and outside vapor-deposition method, and it is possible to manufacture a large optical fiber preform at a low cost.

For lowering the refractive index of a cladding region, the cladding region may be doped with fluorine by flowing a fluorine-containing gas such as CF₄, SiF₄, SF₆ to the sintering furnace when dehydrating and sintering the porous silica body in a sintering furnace.

However, in the case of the bulk density of the porous silica body being high, it is possible to perform the fluorine doping, but it is difficult to diffuse the fluorine-containing gas to the interior of the porous silica body. In that case, even if the processing time with the fluorine-containing gas is increased, it is difficult to uniformly perform fluorine doping in the radial direction and longitudinal direction of the porous silica body.

The Transactions of the Institute of Electronics, Information and Communication Engineers C Vol. J71-C No.2 pp. 212-220 (Non-patent Document 1) discloses the doping of fluorine in a porous silica body. In the document, in order to uniformly dope fluorine, the bulk density of the porous silica body needs to be 1.0 g/cm³ or less.

However, as a result of investigation by the inventors, it was understood that when performing fluorine doping by combining vapor-phase axial deposition method and outside vapor-deposition method and manufacturing an optical fiber perform, even if the bulk density of the porous silica body is simply reduced (for example, 1.0 g/cm³ or less as disclosed in Non-patent Document 1), it is difficult to uniformly perform fluorine doping. The reasons for this shall be given below.

In the case of vapor-phase axial deposition method, glass particles are deposited on a target that traverses (relatively moves) in the perpendicular direction. During that time, the fluctuation of the flame of the burner causes unevenness of the doping concentration of GeO₂ occurs particularly in the core region, which easily causes fluctuation of the refractive index (generally called striae).

The burner for forming the core region deposits glass particles on the target by spraying glass particles obliquely upward toward the target. For that reason, as shown in FIG. 6B, the arc-like striae 61 easily remain in the core region 63 that is manufactured by vapor-phase axial deposition method.

On the other hand, outside vapor-deposition method is a method of manufacturing a porous silica body by depositing glass particles (soot particles) in multiple layers on the periphery of a rotating optical fiber core rod using a plurality of burners. Since the dimensional errors during the manufacture of each burner and the extent of degradation differ, variations in the maximum temperature and temperature distribution occur at the surface on which the glass particles are deposited. For that reason, it is unavoidable that differences in the bulk density will occur between the glass particle layers (soot layer) deposited by the burners.

Also, even within one soot layer that is deposited by one burner, a variation arises in the sintering using an oxy-hydrogen flame. For that reason, a difference in bulk density may arise between the inner side (core material side) and the outer side (surface side) in the soot layer. As a result, stratified striae 62 occur in the circumferential direction in accordance with the bulk density difference in the deposited cladding region 64, as shown in FIG. 6B. Thus in the case of performing fluorine doping by combining vapor-phase axial deposition method and outside vapor-deposition method, the striaes 61 and 62 in different directions occur.

In performing fluorine doping of a porous silica body, the fluorine doping amount depends on the surface area of the porous silica body, that is to say, depends on the bulk density. For that reason, in performing fluorine doping using outside vapor-deposition method, since there are differences in the bulk densities between the soot layers as well as variations within each layer, unevenness of the fluorine concentration occurs in the outside vapor-deposited layer. As a result, the size of the trench portion varies in the radial direction and longitudinal direction of the preform, and between lots, and thus the bending loss of the manufactured optical fiber is no longer stable.

Moreover, when comparing the striae that exists in the preform 64 in which fluorine doping is not performed and the striae that exists in the preform 65 in which fluorine doping is performed, the striae 62 in the preform 65 that is doped with fluorine tends to more easily develop in a significant manner than the preform 64 that is not doped with fluorine (refer to FIG. 6A), due to the influence of the unevenness of the fluorine concentration. In measuring the refractive index profile of the preform that has striae using a preform analyzer or the like, correct measurement of the refractive index profile is difficult since it is difficult to accurately detect the laser diffracted light.

If the direction of the striae is constant, it is possible to measure an accurate refractive index profile by applying a filter to the diffracted light. However, in the case of there being a plurality of striae of mutually different directions, processing of the diffracted light is difficult. In the case of striae being conspicuously generated, that is, in a preform in which conspicuous unevenness of the fluorine concentration exists, processing of the diffracted light is more difficult. Performing an estimation of an optical fiber characteristics based on an inaccurate measurement result of the refractive index profile for a preform will lead to a fluctuation of the optical characteristics such as the cut-off wavelength and bending loss of the manufactured optical fiber (hereinbelow referred to as the optical fiber characteristics), and will become a cause of a reduction in the yield.

In the case of performing fluorine doping by combining vapor-phase axial deposition method and outside vapor-deposition method in the above manner, simply lowering the bulk density of the porous silica body is insufficient for uniform fluorine doping.

Although a number of methods were examined in the past in order to deal with such kind of problem, they cannot be sufficient as methods for uniformly doping porous silica bodies with fluorine.

In Patent Document 2, it is described that when adding a dopant (here, germanium) to a porous silica body, variations in dopant concentration easily occurs. As a result, since striae appear, it is not possible to accurately measure the refractive index profile due to the existence of the striae, and it is difficult to control the optical fiber characteristics.

As a countermeasure, it has been proposed to make the thickness of the soot per one traverse 20 μm or less when converted to the thickness after sintering. In Patent Document 2, although the bulk density of the soot is not disclosed, for example in the case of the preform with a diameter of 20 mm and the bulk density of 0.5 g/cm³, the soot thickness of 20 μm after sintering corresponds to approximately 80 μm when converted to the thickness per a single soot layer, which is extremely thin. In manufacturing such kind of thin soot, in a single soot layer, even if concentration variations of the dopant occur due to bulk density variations thereof, striae and the like are hindered from being generated.

However, in the case of the deposited amount of the glass particles per one traverse being small, the deposition efficiency and deposition speed of the glass particles degrade. As a result, the manufacturing time of the porous silica body increases, leading to a degradation of the manufacturing efficiency. Also, if the thickness of one layer of soot is too thin, the heat of the flame of the burner when providing a soot layer overlapping thereon, the inner layer will be easily vitrified, and thereby causing the problem of the bulk density easily rising while depositing a plurality of soot layers.

For that reason, in order to lower the average bulk density for performing uniform fluorine doping, it is necessary to keep down the bulk density the further to the inside of the porous silica body. However, to do so it is necessary to set the gas flow rate in advance in anticipation of a change in the bulk density due to vitrification. Moreover, the lower the bulk density, the easier soot cracking occurs.

The present invention was achieved in view of the above circumstances, and has an object of providing a manufacturing method of a porous silica body that is capable of uniformly and efficiently performing fluorine doping in a soot layer, a manufacturing method of an optical fiber preform, a porous silica body and an optical fiber preform.

### SUMMARY OF THE INVENTION

In order to solve the aforementioned issues, the present invention employs the following.

(1) A manufacturing method for a porous silica body according to an aspect of the present invention includes: a step of arranging a plurality of burners around an optical fiber core rod; and a deposition step of depositing a plurality of soot layers on an outer peripheral surface of the optical fiber core rod by the burners, in which the deposition step comprises forming each of the plurality of soot layers by one of the burners, and depositing each soot layer to satisfy 0.2≦x≦0.5 and 0.1≦y≦4.0x²−3.8x+1.3 where x (g/cm³) is the average bulk density and y (mm) is the deposition thickness, and so that the maximum value of the bulk density of the soot layers becomes 0.6 g/cm³ or less.

(2) In the aforementioned manufacturing method for a porous silica body, it may be arranged such that each soot layer is deposited so as to satisfy 0.2≦x≦0.5 and 0.1≦y≦0.4.

(3) In the aforementioned manufacturing method for a porous silica body, it may be arranged such that the optical fiber core rod is manufactured by vapor-phase axial deposition method.

(4) A manufacturing method for an optical fiber preform according to an aspect of the present invention includes dehydrating and sintering in a fluorine-containing gas a porous silica body manufactured by the manufacturing method of (1) or (3).

(5) A porous silica body according an aspect of the present invention includes a plurality of soot layers deposited on an outer peripheral surface of an optical fiber core rod, wherein the maximum value of a bulk density of the soot layers is 0.6 g/cm3 or less, and each soot layer satisfies 0.2≦x≦0.5 and 0.1≦y≦4.0x2−3.8x+1.3, when x (g/cm3) is an average bulk density and y (mm) is a deposition thickness.

(6) In the aforementioned porous silica body, it may be arranged such that each soot layer satisfies 0.2≦x≦0.5 and 0.1≦y≦0.4.

(7) An optical fiber preform according to an aspect of the present invention is manufactured by dehydrating and sintering, in a fluorine-containing gas, the porous silica body of (5).

According to the aforementioned manufacturing method for a porous silica body, manufacturing method for an optical fiber preform, porous silica body, and optical fiber preform, it is possible to uniformly and efficiently perform fluorine doping in a soot layer.

### BRIEF DESCRIPTION OF THE DRAWINGS

FIG. 1 is a view that shows an example of the refractive index profile of an optical fiber obtained from an optical fiber preform that is manufactured by the manufacturing method according to an embodiment of the present invention, and the cross section thereof.

FIG. 2 is a schematic view of an outside vapor deposition device that deposits soot layers on the outer peripheral surface of an optical fiber core rod.

FIG. 3 is a view that shows the step of outside vapor depositing a plurality of soot layers with a plurality of burners.

FIG. 4A is a view for describing the method of calculating the irregularity of the relative refractive index difference of the optical fiber preform.

FIG. 4B is a cross-sectional view of the optical fiber preform according to an embodiment of the present invention.

FIG. 5A is a view that shows the measurement result of the refractive index profile in each example.

FIG. 5B is a view that shows the measurement result of the refractive index profile in each comparative example.

FIG. 6A is a pattern diagram for describing striae in an optical fiber preform.

FIG. 6B is a pattern diagram for describing striae in an optical fiber preform.

FIG. 7 is a view that shows combination of the thickness of one soot layer and average bulk density in each example and comparative example.

### DETAILED DESCRIPTION OF THE PREFERRED EMBODIMENTS

### [Optical Fiber]

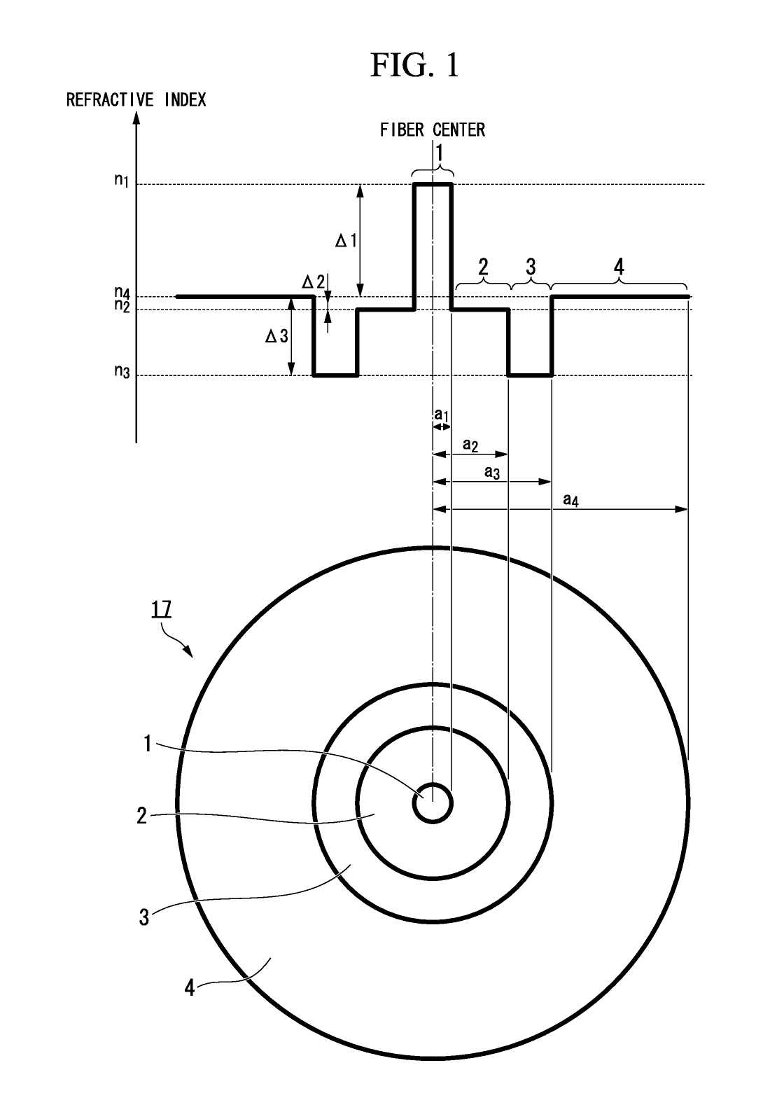

FIG. 1 is a view that shows a cross section of an optical fiber 17 and an embodiment of the refractive index profile thereof The optical fiber 17 of FIG. 1 is manufactured by heating an optical fiber preform that is manufactured by the manufacturing method for an optical fiber preform described below and finely elongating (drawing) it to a thickness of around 125 μm. The optical fiber preform has substantially the same refractive index profile structure, with respect to the ratio, as that of the optical fiber 17. By heating and elongating the optical fiber preform, the optical fiber 17 is manufactured that follows the refractive index structure of the optical fiber preform.

A core 1 with a radius a₁ and a maximum refractive index n₁ is provided in the center of the optical fiber 17 of FIG. 1. A first cladding layer 2 with an outer radius a₂ and a maximum refractive index n₂ is provided on the outer periphery of the core 1. A second cladding layer 3 with an outer radius a₃ and a maximum refractive index n₃ is provided on the outer periphery of the first cladding layer 2. A third cladding layer 4 with an outer radius a₄ and a maximum refractive index n₄ that forms the outermost layer of the optical fiber 17 is provided on the outer periphery of the second cladding layer 3.

In the present specification, when the outer radius of a given layer is aₙ, and the outer radius of the inside adjacent layer is aₙ₋₁, maximum refractive index denotes the largest refractive index (the largest refractive index in one layer) between aₙ₋₁ and aₙ. Here, n is an integer of 1 or greater, and aₒ=0(μm). In the refractive index profile with the step shape as shown in FIG. 1, the refractive index is constant from aₙ₋₁ to aₙ (i.e., the refractive index within one layer is constant). However, in the case of refractive index variations existing within a layer, the maximum refractive index that is defined by the aforementioned method is used.

In the optical fiber 17, the maximum refractive index n₁ of the core 1 is designed to be larger than any of the maximum refractive index n₂ of the first cladding layer 2, the maximum refractive index n₃ of the second cladding layer 3, and the maximum refractive index n₄ of the third cladding layer 4. On the other hand, the maximum refractive index n₃ of the second cladding layer 3 is designed to be smaller than either of the maximum refractive index n₂ of the first cladding layer 2 and the maximum refractive index n₄ of the third cladding layer 4.

The refractive index profile of the optical fiber is formed by adding a dopant such as germanium or fluorine. In the processes used in optical fiber manufacture such as vapor-phase axial deposition method, chemical vapor deposition method, or outside vapor-deposition method, due, for example, to the effect of diffusion of the dopant, the boundary of each layer in the refractive index profile may become vague.

In the optical fiber 17 shown in FIG. 1, the refractive index in the first cladding layer 2 is substantially constant in the radial direction, and the refractive index profile of the entire optical fiber 17 has a stepped shape. The refractive index profile of the optical fiber according to the present invention does not necessarily need have a perfect stepped shape. In the case of the refractive index profile not having a stepped shape, the diameter of each layer is defined by the following.

First, the radius a₁ of the core 1 is defined as the distance from the position at which the relative refractive index difference decreases to 1/10 of the maximum value Δ₁ of the relative refractive index difference in the core 1 to the fiber center. Also, the outer radius a₂ of the first cladding layer 2 and the outer radius a₃ of the second cladding layer 3 are each defined as the distance from the position at which dΔ(r)/dr takes an extremal value to the fiber center, the dΔ(r)/dr being the differential value of the radial profile Δ(r) of the relative refractive index difference (r expressing the radius).

The relative refractive index difference Δi (unit: %) of each layer in the optical fiber 17 is based on the maximum refractive index n₄ of the third cladding layer 4, and is expressed by the following Equation (1).

$$\begin{matrix}[ Equation 1 ] & \\ {Δ}_{i} = \frac{{n}_{i} - {n}_{4}}{{n}_{4}} \times 100 & ( 1 )\end{matrix}$$

(In the equation, i is an integer between 1 and 3, and nᵢ is the maximum refractive index of each layer.)

### [Manufacturing Method of Optical Fiber Preform]

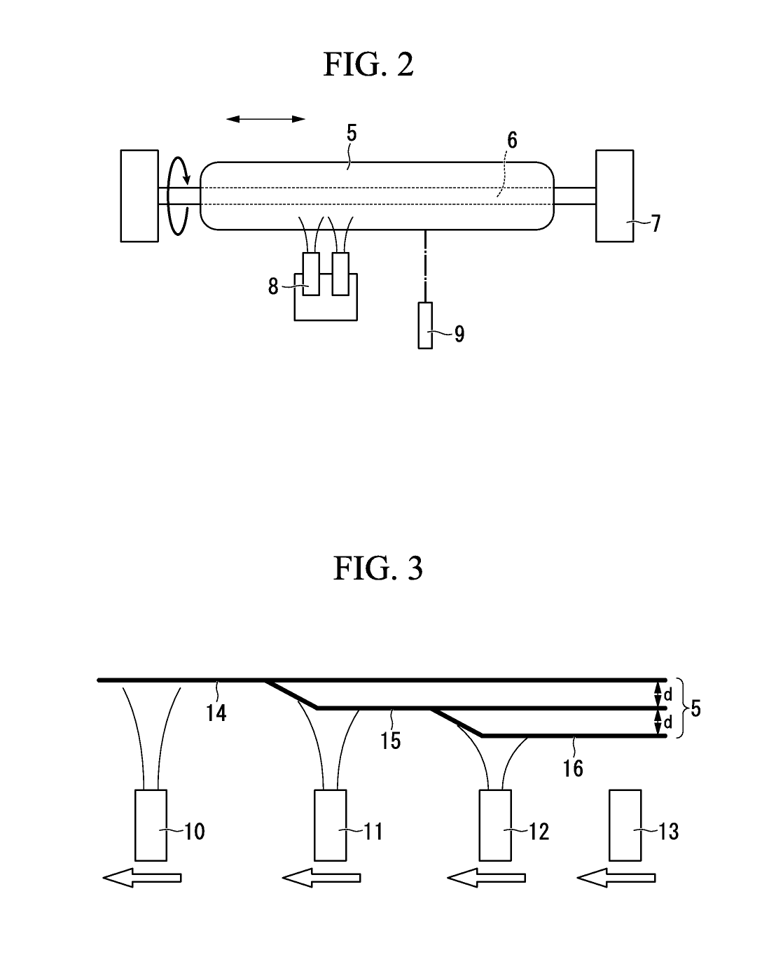

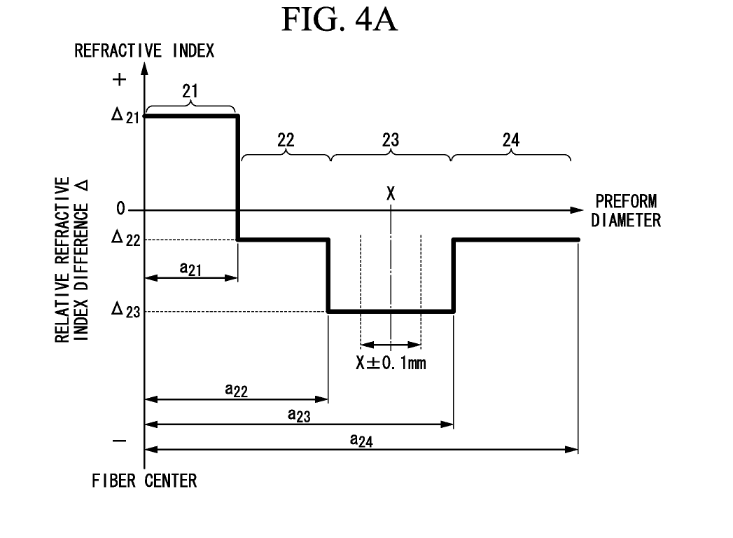

Next, the manufacturing method of the optical fiber preform for manufacturing the optical fiber 17 of FIG. 1 shall be described, using FIG. 2 to FIG. 5B. FIG. 2 is a schematic view of an outside vapor deposition device that deposits glass particles that become the cladding material on the periphery of the optical fiber core rod including the core region that serves as the core of the optical fiber. Also, FIG. 3 is a mimetic view that shows the step in which layers of glass particles (soot layer) are externally deposited in a layer shape one-by-one by the burners 10, 11, 12, 13.

In FIG. 2, the optical fiber core rod 6 is constituted from a core region that becomes the core 1 of the optical fiber 17, and a first cladding portion that becomes the first cladding layer 2 of the optical fiber 17. The optical fiber core rod 6 is manufactured by vapor-phase axial deposition method. In vapor-phase axial deposition method, gas that is the source material of the optical fiber is fed to a burner along with oxygen and hydrogen, and glass particles are deposited by spraying the source material gas along with an oxy-hydrogen flame from below a rotating silica rod, and by heating this to turn it into a transparent glass, a rod-shaped core preform is manufactured.

Both ends in the longitudinal direction of the optical fiber core rod 6 are supported in a rotatable manner by the support members 7. A plurality of burners 8 are arranged at the periphery of the optical fiber core rod 6, and the optical fiber core rod 6 and the plurality of burners 8 are capable of traversing (relative movement) in the longitudinal direction (the direction parallel with the rotational axis) of the optical fiber core rod 6. The gas that is the glass source material is fed to the burner 8 along with the oxygen and hydrogen, and the glass particles that are generated in the burner flame are sprayed on the outer peripheral surface of the optical fiber core rod 6, and the porous silica body 5 is manufactured. Note that in FIG. 2, both ends of the optical fiber core rod 6 are directly supported by the support members 7, but at both ends of the optical fiber core rod 6, a dummy rod (not illustrated) may be flame welded as necessary, and this dummy rod may be supported in a rotatable manner by the support members 7.

A layer of glass particles of one layer (soot layer) is outside deposited by each burner 1 during one traverse on the outer peripheral surface of the optical fiber core rod 6, and a layer of glass particles (soot layer) that is deposited in a layer shape is formed. The thickness of the glass particles that are deposited on the optical fiber core rod 6 (the outer diameter of the porous silica body 5) is measured by a displacement measurement instrument using a laser light source 9. In this displacement measurement instrument, the distance between the laser light source 9 and the porous silica body 5 is measured by a displacement sensor that is not illustrated. In the outside vapor deposition device of FIG. 2, the outside vapor deposition conditions such as the flow rate of the source material gas and the flow rate of the oxy-hydrogen flame are controlled so that the thickness and bulk density of each soot layer is uniform, each soot layer being outside deposited by an individual burner (although the thickness and bulk density of the different soot layers may or may not be the same). Information relating to the outside vapor deposition amount per one traverse that is measured by the displacement measurement instrument during one outside vapor deposition step is stored in a storage device not illustrated together with the outside vapor deposition conditions of the burner used in that outside vapor deposition step. The information relating to the outside vapor deposition conditions of the burner and the outside vapor deposition amount stored in the storage device is reflected in the outside vapor deposition conditions of the burner in the next outside vapor deposition step.

Glass particles that are deposited on the optical fiber core rod 6 are dehydrated and sintered in the sintering furnace. Then, by repeating the aforementioned process of depositing glass particles and the process of sintering glass particles, a second cladding portion that becomes the second cladding layer 3 of the optical fiber 17, and the third cladding portion that becomes the third cladding layer 4 of the optical fiber 17 are in turn formed on the outer peripheral surface of the optical fiber core rod 6. In the case of performing a sintering process on the plurality of soot layers that become the second cladding portion, doping of the second cladding portion with fluorine is performed by introducing a fluorine-containing gas such as CF₄, SiF₄, SF₆ to the sintering furnace so that the refractive index of the second cladding portion becomes less than the refractive index of the first cladding portion and the third cladding portion. As explained above, an optical fiber preform is manufactured that has the same refractive index profile structure, with respect to the ratio, as the refractive index profile structure of the optical fiber 17 shown in FIG. 1.

As shown in FIG. 3, in the outside vapor deposition device of the present embodiment, the plurality of burners 10, 11, 12, 13 are arranged substantially equally spaced along the longitudinal direction of the optical fiber core rod 6. In FIG. 3, the four burners 10, 11, 12, 13 are shown, but the number of burners is not limited thereto. The relative positions of both the burners 10, 11, 12, 13 and the optical fiber core rod 6 change when one of them is fixed and the other moves leftward or rightward (in one direction along the longitudinal direction of the optical fiber core rod 6).

As the source material gas that is fed to the burners 10, 11, 12, 13, SiCl₄ (tetrachlorosilane) is used. The SiCl₄ that is fed to the burners 10, 11, 12, 13 along with oxygen and hydrogen turns to glass particles in the flames of the burners 10, 11, 12, 13. These glass particles are deposited on the outer peripheral surface of the optical fiber core rod 6 that is rotating. Then, by causing the burners 10, 11, 12, 13 to traverse the longitudinal direction (rotation axis direction) of the optical fiber core rod 6 while rotating the optical fiber core rod 6, a plurality of glass particle layers (soot layers) 14, 15, 16 are deposited on the outer peripheral surface of the optical fiber core rod 6. The glass particle layers (soot layers) 14, 15, 16 that are outside vapor deposited by the burners with each traverse are laminated one layer at a time on the outer peripheral surface of the optical fiber core rod 6. A single soot layer is manufactured by a single burner traversing in one direction along the longitudinal direction of the optical fiber core rod 6. By causing a single burner to traverse n times along the longitudinal direction of the optical fiber core rod 6, n soot layers are manufactured. Accordingly, in FIG. 3, by causing the plurality of burners 10, 11, 12, 13 to traverse a plurality of times, it is possible to manufacture a porous silica body that has a plurality of soot layers on the outer peripheral surface of the optical fiber core rod.

In order to uniformly and efficiently dope fluorine in the porous silica body 5 that is manufactured by outside vapor-deposition method, it is important to control within a fixed range the bulk density of the soot (glass particles) and the thickness d of the soot layer that is deposited by one burner in the outside vapor-deposition step.

The bulk density that is the first point shall be described. By performing manufacturing so that the bulk density of a region that is manufactured by outside vapor-deposition method is high at the early phase of deposition to the optical fiber core rod 6 and decreases toward the outer periphery, the effect of distortion reduction accompanying shrinkage during sintering can be obtained. As a result of investigating various conditions, with regard to bulk density it was found that it is necessary to put the bulk density of each soot layer and the average bulk density of the soot layers in a predetermined range.

Here, the bulk density of each soot layer is defined as the bulk density of each soot layer that is deposited by one of the burners during one traverse. For example, in the case of manufacturing the porous silica body 5 by the four burners as shown in FIG. 3 (depositing glass particles from the inner layer side of the porous silica body 5 in the order of burner 10→burner 11→burner 12→burner 13→burner 10 and so on), the thickness of a single soot layer that is manufactured by the burner 11 is calculated using the outer diameter of the burner 10 and the burner 11 and the deposited weight of the glass particles. Alternatively, for convenience, the thickness and the deposition weight of soot layers every two burners may be calculated, and the quotient of dividing them by 2 may serve as the thickness and weight of one soot layer.

For example, in the case of depositing glass particles with four burners in the same manner as mentioned above, the outer diameter of the porous silica body after depositing two soot layers by the burners 10 and 11, and the outer diameter of the porous silica body after depositing four soot layers by the burners 10, 11, 12, 13 are respectively measured. From the data, the thickness of the two soot layers deposited by the burner 12 and the burner 13 is found. The quotient of dividing the thickness of the two soot layers by 2 may be regarded as the respective thickness of the soot layers manufactured by the burner 12 and the burner 13.

Average bulk density is defined as the density that is obtained from the thickness of the whole deposited soot layers, the deposition weight, and the preform length, the thickness being obtained from the outer diameter of the final porous silica body and the outer diameter of the starter core material (the optical fiber core rod. In the case of forming the preform by forming the porous silica body on the outer peripheral surface of the optical fiber core rod and performing a sintering process, the preform formed by the latest sintering process).

In the present embodiment, by measuring the distance between the laser light source and the porous silica body by a displacement sensor (for example, LK-2000 made by Keyence), and continuously calculating the outer diameter of the porous silica body, the bulk density of each soot layer and the average bulk density of all the soot layers are calculated. Adjustment of the bulk density of the porous silica body (soot layer) can be performed by adjustment of the flow rate of the source material gas and the flow rate of the oxy-hydrogen flame, and increasing the diameter of the starter core material. In the present embodiment, reduction of the bulk density is performed by lowering the flow rate of the hydrogen gas and lowering the surface temperature when glass particles are being deposited.

As conditions of performing uniform fluorine doping and reducing delamination defects that occur during vitrification, the maximum value of the bulk density of the soot layers of the porous silica body (generally, the soot layer that is most to the inner layer side among all the soot layers that are outside vapor-deposited) is 0.6 g/cm³ or less, and the average bulk density should be suitably set from a range of 0.2 g/cm³ or more and 0.5 g/cm³ or less depending on the thickness of the soot layer.

In the case of the maximum bulk density being larger than 0.6 g/cm³, it becomes no longer possible to perform the desired amount of fluorine doping in the soot layer that is to the inside of that layer, and so the dehydration is not sufficient. For that reason, in an optical fiber that is manufactured from such kind of optical fiber preform, there is the problem of the loss (OH loss) at a wavelength of 1383 nm increasing. On the other hand, when the lower limit of the bulk density of each soot layer is less than 0.2 g/cm³, defects easily occur such as the glass layer delamination due to contraction distortion during sintering and vitrifying increasing. For that reason, for the actual operation, the bulk density of the soot layers is preferably 0.2 to 0.6 g/cm³.

When the average bulk density x (g/cm³) is greater than 0.5 g/cm³, the production efficiency degrades, because the fluorine diffusion becomes slow, and the traverse speed of the porous silica body that passes through the heater becomes slow. Although there are no particular constraints on the lower limit of the average bulk density, when it is lower than 0.2 g/cm³, problems occur such as the porous silica body 5 easily cracking during conveyance and the like, or the outer diameter of the porous silica body 5 increasing, leading to a large sintering furnace being necessary. Therefore, for actual operation, 0.2 to 0.5 g/cm³ (0.2≦x≦0.5) is preferred.

The thickness y (mm) of one soot layer that is manufactured by one burner that is the second point, with the average bulk density x (g/cm³) in the range of 0.2≦x≦0.5, is preferably in a range of 0.1≦y≦4.0x²−3.8x+1.3. In particular, with the average bulk density x (g/cm³) being in a range of 0.2≦x≦0.5 and the thickness y (mm) of one soot layer being in a range of 0.1≦y≦0.4, it is possible to perform deposition of a soot layer with good efficiency.

In the case of the thickness of one soot layer being thicker than 4.0x²−3.8x+1.3 (mm), variations in the bulk density within one soot layer easily increase, and unevenness of the fluorine doping amount is produced. As a result, striae is observed by a refraction index profile measurement apparatus (preform analyzer), accurate measurement of the refraction index profile cannot be performed, and so stabilizing the fiber characteristics becomes difficult.

On the other hand, when the thickness of one soot layer is thinner than 0.1 mm, the deposition efficiency of glass particles degrades, easily leading to a cost increase.

Also, if the thickness of one soot layer is 0.1 mm or greater, since shrinkage of a soot layer by the heat of the burner flame when manufacturing an overlapping soot layer is relaxed, it is possible to avoid a rise in the bulk density while depositing a plurality of soot layers.

Here, in order to quantitatively express the extent of the striae, the irregularity in the refractive index profile of the optical fiber preform is defined by Equation (2) below.

$$\begin{matrix}[ Equation 2 ] & \\ Irregularity at position X = \frac{Δ at X}{Moving average of Δ in range of X \pm 0.1 mm} & ( 2 )\end{matrix}$$

Note that the range used for the moving average should be suitably selected depending on the measurement step, the number of data, and shape of the refractive index profile. In the present embodiment, when a given measurement position is made to be X, the moving average of the relative refractive index difference Δ is taken in a range of X±0.1 mm in the preform diameter direction. Here, “Δ at X” in the aforementioned Equation (2) denotes the relative refractive index difference Δ, with respect to the core region, at position X. The measurement interval during measurement of the refractive index profile is 20 μm in the present embodiment.

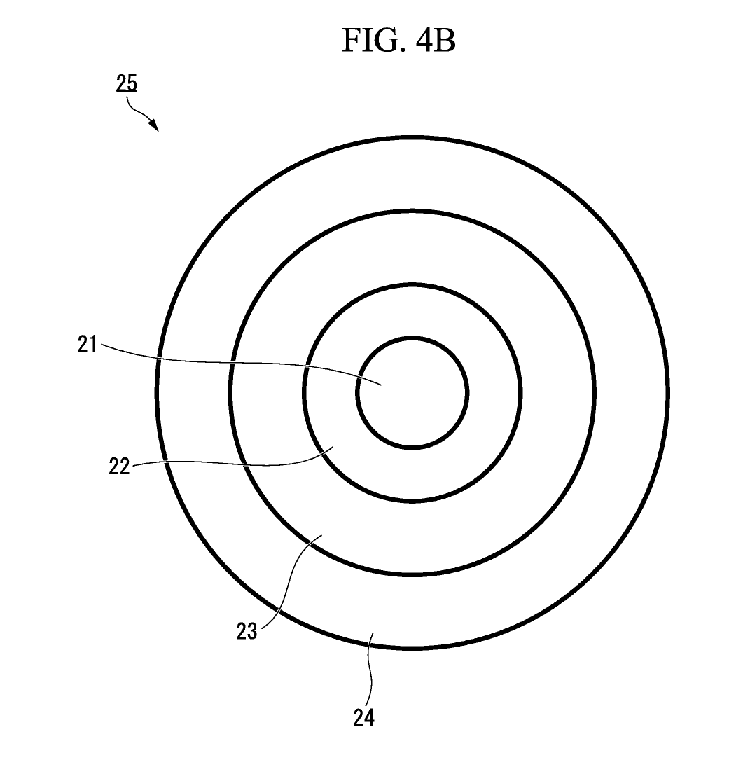

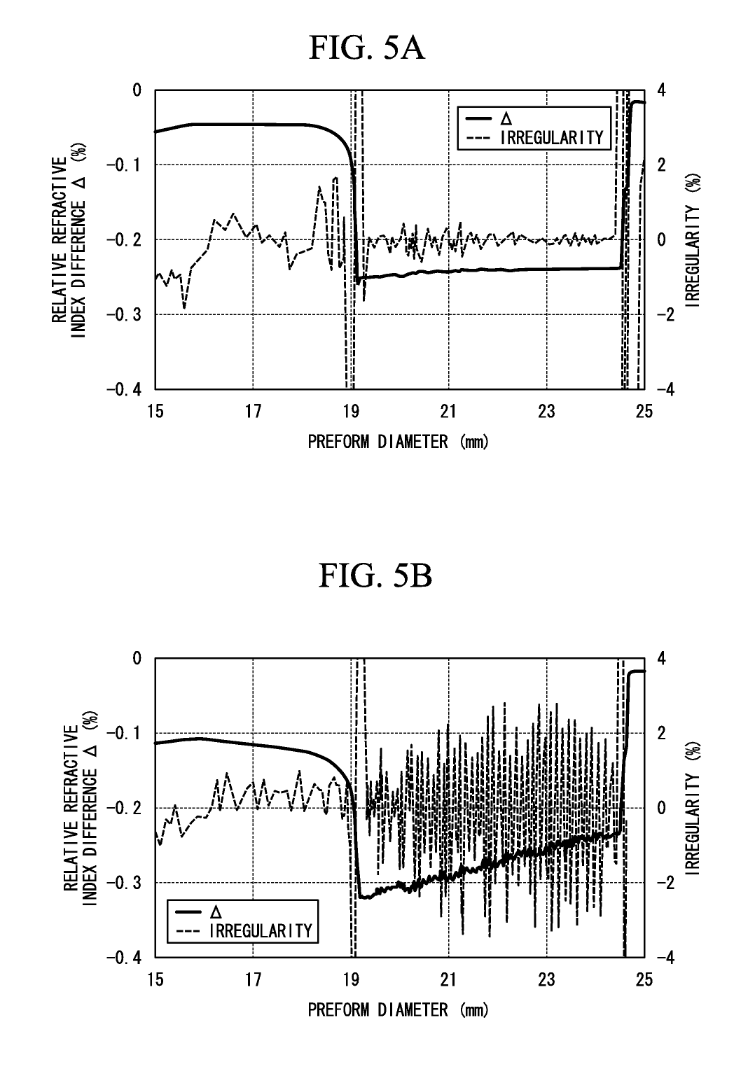

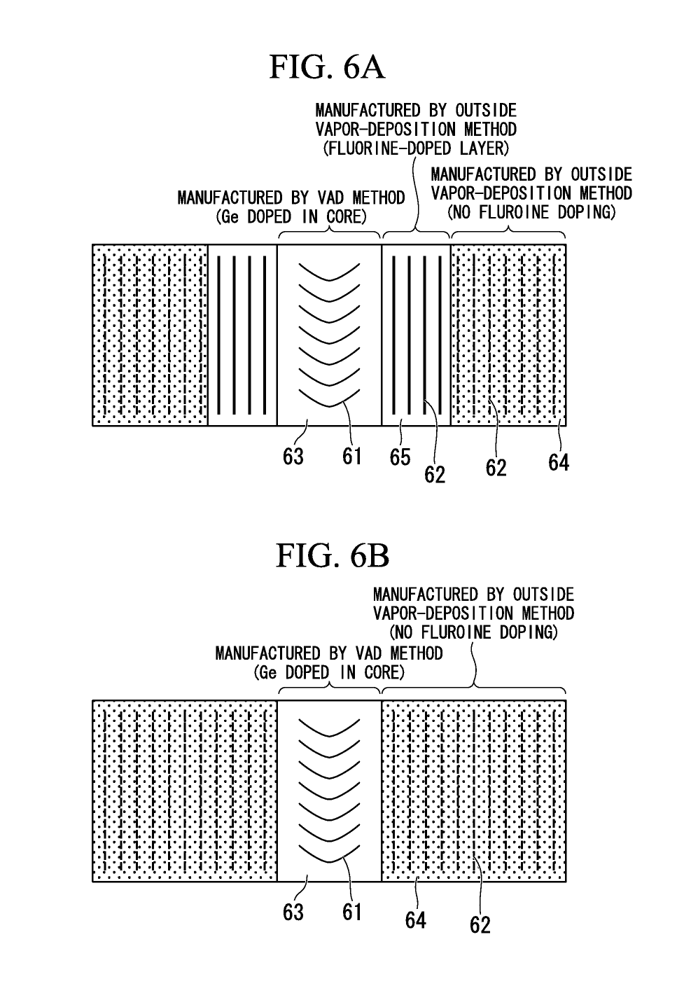

FIG. 4A shows the range used in the calculation of the irregularity. FIGS. 5A and 5B show an example of the refractive index profile in an actual optical fiber.

FIGS. 4A and 4B are views that show the optical fiber preform 25 according to the present embodiment, and the refractive index profile thereof. The optical fiber preform 25 of FIGS. 4A and 4B has substantially the same refractive index profile structure in relation to the ratio with the refractive index profile of the optical fiber 17 shown in FIG. 1. That is to say, a core region 21 with a radius a₂₁ and maximum refractive index n₂₁, which becomes the core 1 of the optical fiber 17, is provided at the center of the optical fiber preform 25. A first cladding portion 22 with an outer radius a₂₂ and a maximum refractive index n₂₂ that becomes the first cladding layer 2 of the optical fiber 17 is provided on the outer periphery of the core region 21. Also, a second cladding portion 23 with an outer radius a₂₃ and a maximum refractive index n₂₃, that becomes the second cladding layer 3 of the optical fiber 17, is provided on the outer periphery of the first cladding portion 22. Then, a third cladding portion 24 with an outer radius a₂₄ and a maximum refractive index n₂₄, that becomes the third cladding layer 4 of the optical fiber 17 and forms the outermost layer of the optical fiber preform 25, is provided on the outer periphery of the second cladding portion 23.

The size of the maximum refractive index n₂₁ of the core region 21 of the optical fiber preform 25 is substantially the same as the size of the maximum refractive index n₁ of the core region 1 of the optical fiber 17. The size of the maximum refractive index n₂₂ of the first cladding portion 22 of the optical fiber preform 25 is substantially the same as the size of the maximum refractive index n₂ of the first cladding layer 2 of the optical fiber 17. The size of the maximum refractive index n₂₃ of the second cladding portion 23 of the optical fiber preform 25 is substantially the same as the size of the maximum refractive index n₃ of the second cladding layer 3 of the optical fiber 17. The size of the maximum refractive index n₂₄ of the third cladding portion 24 of the optical fiber preform 25 is substantially the same as the size of the maximum refractive index n₄ of the third cladding layer 4 of the optical fiber 17. Also, the ratio of the size of the core region 21 and each cladding portion 22, 23, 24 (a₂₁:a₂₂:a₂₃:a₂₄) is the same as the ratio of the size of the core 1 of the optical fiber 17 and each cladding layer 2, 3, 4 (a₁:a₂:a₃:a₄). Note that the maximum refractive indices of the constituent elements of the optical fiber preform 25 (core region 21, first cladding portion 22, second cladding portion 23, third cladding portion 24) and the constituent elements of the optical fiber 17 (core 1, first cladding layer 2, second cladding layer 3, third cladding layer 4) being “substantially the same” means that both are the same in the case of ignoring the effects such as drawing tension when drawing the optical fiber preform 25.

The maximum refractive index n₂₁ of the core region 21 is larger than any of the maximum refractive index n₂₂ of the first cladding portion 22, the maximum refractive index n₂₃ of the second cladding portion 23, and the maximum refractive index n₂₄ of the third cladding portion 24. On the other hand, the maximum refractive index n₂₃ of the second cladding portion 23 is smaller than either of the maximum refractive index n₂₂ of the first cladding portion 22 and the maximum refractive index n₂₄ of the third cladding portion 24.

The method of defining each diameter of the core region 21, the first cladding portion 22, the second cladding portion 23, and the third cladding portion 24 is the same as the method of defining each diameter of the core 1, the first cladding layer 2, the second cladding layer 3, and the third cladding layer 4 of the optical fiber 17. That is to say, the radius a₂₁ of the core region 21 is defined as the distance from the position at which the relative refractive index difference decreases to 1/10 of the maximum value Δ₂₁ of the relative refractive index difference in the core region 21 to the preform center (fiber center). Also, the outer radius a₂₂ of the first cladding portion 22 and the outer radius a₂₃ of the second cladding portion 23 are each defined as the distance from the position at which dΔ(r)/dr takes an extremal value to the preform center (fiber center), the dΔ(r)/dr being the differential value of the radial profile Δ(r) of the relative refractive index difference (r expressing the radius). Also, the relative refractive index differences n₂₁, n₂₂, n₂₃, n₂₄ of the core region 21, the first cladding portion 22, the second cladding portion 23, and the third cladding portion 24 have the same calculation method as the relative refractive index differences of the core 1, the first cladding layer 2, the second cladding layer 3, and the third cladding layer 4 of the optical fiber 17 described using Equation (1), except for the reference point of the refractive index being the maximum refractive index n₂₄ of the third cladding portion 24.

As shown in FIG. 5B, in the case of large striae being produced in the second cladding portion (trench portion) that is the fluorine-doped region of the optical preform (in the case of an optical fiber that is manufactured by a conventional manufacturing method), a jagged line appears in the graph of the refractive index profile. The variations of the irregularity in that case are ±2% or more. On the other hand, in the case of striae of the second cladding portion being small as shown in FIG. 5A (in the case of an optical fiber that is manufactured by the manufacturing method of the present invention), a smooth line appears in the graph of the refractive index profile, and the variations of the irregularity are as small as ±0.5%.

In relation to the present embodiment, if there is striae in which the variations of the irregularity are ±1% or less at the second cladding portion 23 (since the refractive index difference greatly changes in the vicinity of the first cladding portion 22 and the third cladding portion 24, it is omitted), it was found that it is possible to measure an accurate refractive index profile with a preform analyzer. As a result, the characteristic estimation of the optical fiber at the stage of the optical fiber preform can be performed well, and manufacturing a stable optical fiber is facilitated.

Here, the judgment of whether or not an accurate refractive index profile has been measured by the preform analyzer is performed by a comparison with an analysis of the fluorine concentration by a Raman spectroscopy measurement that is separately performed. Specifically, the fluorine concentration is calculated by a Raman spectroscopy measurement, and the refractive index profile corresponding to the fluorine concentration is obtained by converting that to a relative refractive index difference. By comparing this result and the refractive index profile that is obtained using the preform analyzer, a judgment is made as to whether or not an inappropriate measurement due to striae has occurred.

In order to make the thickness of one soot layer thin, it is possible to adjust the traverse speed of the burners and the main shaft rotational frequency of the optical fiber core rod 6 can be adjusted. According to the investigation by the inventors, it was confirmed that increasing the burner traverse speed is more effective. As described above, with the average bulk density x (g/cm³) in the range of 0.2≦x≦0.5, when the thickness y (mm) of one soot layer that is manufactured by one burner is in the range of 0.1≦y≦4.0x²−3.8x+1.3, it is possible to suppress the generation of striae. In particular, with the average bulk density x (g/cm³) being in a range of 0.2≦x≦0.5 and the thickness y (mm) of one soot layer being in a range of 0.1≦y≦0.4, it is possible to perform deposition of a soot layer with good efficiency. It should be noted that, in the case of satisfying the aforementioned conditions, it is not necessary to take contraction of the bulk density into consideration even after depositing soot layers in an overlapping manner.

### EXAMPLES

Hereinbelow, the embodiment of the present invention shall be described in detail with examples.

First, as Example 1, outside vapor deposition of glass particles is performed using eight multi-nozzle silica burners on an optical fiber core rod (average core relative refractive index difference Δ₁: 0.35%) measuring φ42×1200 mm that is manufactured by vapor-phase axial deposition method. The gas flow rates are as follows: SiCl₄ flow rate: 2 to 5 SLM, oxygen flow rate: 18 to 35 SLM, hydrogen flow rate: 25 to 45 SLM, sealing Ar gas: 1 SLM. The main-axis rotational frequency of the targeted optical fiber core rod is 25 rpm, and the traverse speed of each burner is 220 mm/min.

The surface temperature of the porous silica body during the outside vapor deposition, was measured using a Thermo Tracer (Type TH3104MR, NEC San-ei Instruments, Ltd.), and it was found that the temperature was 1050° C. during deposition of the innermost layer, and 880° C. during outside vapor deposition of the outermost layer.

Measurement of the bulk density during the outside vapor deposition was continuously performed by the following method. Using a laser, the distance between the laser light source and the surface of the porous silica body was measured, and the thickness of the soot layer deposited from that point was calculated. In the present example, the thickness of the porous silica body was obtained for each manufacture of the layer deposited by two burners (corresponding to two layers), and the quotient of dividing the calculated thickness by 2 is the thickness of each soot layer manufactured by one of the burners. The bulk density for one layer was calculated from the thickness of the soot layer, the deposition weight, and the deposition distance.

The outer diameter of the porous silica body after the completion of the outside vapor deposition is φ90 mm, the average bulk density is 0.43 g/cm³, and the maximum bulk density among the soot layers is 0.55 g/cm³. Also, the calculated thickness of one soot layer (average deposition thickness) is 0.2 mm.

This porous silica body was set in a silica muffle and sintered in a mixed gas of He and SiF₄ to make a φ50 mm optical fiber preform. At this time, the SiF₄ concentration in the silica muffle was 1.5%, and SiF₄ gas was used until the sintering is complete.

After elongating the sintered optical fiber preform to φ35 mm, the refractive index profile was measured using a preform analyzer. The relative refractive index difference Δ₃: was stable in a range of −0.24 to −0.26% in both the radial direction and longitudinal direction. The irregularity of the second cladding portion (trench portion) was calculated using refractive index data and found to be excellent with a fluctuation of ±0.5%. Afterward, the third cladding portion was manufactured by outside vapor-deposition method, to make the final optical fiber preform.

Next, optical fiber preforms according to Examples 2 to 18 and Comparative Examples 1 to 9 were manufactured by the same method as Example 1. The manufacturing conditions of each of the examples and comparative examples are summarized in Table 1 to Table 4. The manufacturing conditions of the optical fiber preforms according to Examples 2 to 18 and Comparative Examples 1 to 9 are the same as for Example 1 except for those shown in Table 1 to Table 4.

TABLE 1

| Item | Example 1 | Example 2 | Example 3 | Example 4 | Example 5 |
|---|---|---|---|---|---|
| Average core Δ1 (%) | 0.35 | 0.34 | 0.34 | 0.35 | 0.34 |
| Main-axis rotational frequency (rpm) | 25 | 25 | 25 | 25 | 25 |
| Burner traverse speed (mm/min) | 220 | 165 | 220 | 110 | 330 |
| Temperature during outside | | | | | |
| vapor deposition (° C.) | | | | | |
| max | 1050 | 1030 | 1090 | 1070 | 970 |
| min | 880 | 900 | 920 | 900 | 830 |
| Average bulk density (g/cm3) | 0.43 | 0.41 | 0.49 | 0.50 | 0.20 |
| Maximum bulk density among soot | 0.55 | 0.52 | 0.60 | 0.59 | 0.30 |
| layers (g/cm3) | | | | | |
| Thickness of one soot layer (mm) | 0.20 | 0.40 | 0.21 | 0.39 | 0.10 |
| Variations of relative refractive index | −0.24~−0.26 | −0.23~−0.25 | −0.23~−0.26 | −0.23~−0.25 | −0.24~−0.25 |
| difference Δ3 of trench portion (%) | | | | | |
| Irregularity of refractive index profile | ±0.5 | ±1.0 | ±0.6 | ±1.2 | ±0.2 |
| of trench portion (%) | | | | | |
| Capability of refractive index | Capable | Capable | Capable | Capable | Capable |
| measurement | | | | | |
| Comprehensive decision | Good | Good | Good | Good | Good |
| Item | Example 6 | Example 7 | Example 8 | Example 9 | Example 10 |
| Average core Δ1 (%) | 0.30 | 0.40 | 0.44 | 0.51 | 0.55 |
| Main-axis rotational frequency (rpm) | 25 | 25 | 25 | 25 | 25 |
| Burner traverse speed (mm/min) | 220 | 220 | 220 | 220 | 220 |
| Temperature during outside | | | | | |
| vapor deposition (° C.) | | | | | |
| max | 1040 | 1055 | 1060 | 1040 | 1050 |
| min | 880 | 880 | 900 | 890 | 880 |
| Average bulk density (g/cm3) | 0.41 | 0.41 | 0.44 | 0.43 | 0.42 |
| Maximum bulk density among soot | 0.57 | 0.59 | 0.60 | 0.55 | 0.53 |
| layers (g/cm3) | | | | | |
| Thickness of one soot layer (mm) | 0.21 | 0.20 | 0.23 | 0.21 | 0.22 |
| Variations of relative refractive index | −0.21~−0.23 | −0.18~−0.21 | −0.30~−0.33 | −0.35~−0.38 | −0.24~−0.28 |
| difference Δ3 of trench portion (%) | | | | | |
| Irregularity of refractive index profile | ±0.4 | ±0.6 | ±0.8 | ±0.4 | ±0.5 |
| of trench portion (%) | | | | | |
| Capability of refractive index | Capable | Capable | Capable | Capable | Capable |
| measurement | | | | | |
| Comprehensive decision | Good | Good | Good | Good | Good |

TABLE 2

| Item | | Example 11 | Example 12 | Example 13 | Example 14 |
|---|---|---|---|---|---|
| Average core Δ1 (%) | | 0.35 | 0.33 | 0.34 | 0.37 |
| Main-axis rotational frequency (rpm) | | 25 | 25 | 25 | 25 |
| Burner traverse speed (mm/min) | | 165 | 300 | 220 | 180 |
| Temperature during | max | 980 | 1030 | 1000 | 1015 |
| outside vapor | min | 840 | 900 | 870 | 880 |
| deposition (° C.) | | | | | |

| | | | | |
|---|---|---|---|---|
| Average bulk density (g/cm3) | 0.21 | 0.40 | 0.25 | 0.35 |
| Maximum bulk density among soot | 0.30 | 0.51 | 0.33 | 0.47 |
| layers (g/cm3) | | | | |
| Thickness of one soot layer (mm) | 0.35 | 0.15 | 0.18 | 0.25 |
| Variations of relative refractive index | −0.24~−0.25 | −0.23~−0.25 | −0.24~−0.25 | −0.23~−0.26 |
| difference Δ3 of trench portion (%) | | | | |
| Irregularity of refractive index profile | ±0.3 | ±0.4 | ±0.3 | ±0.6 |
| of trench portion (%) | | | | |
| Capability of refractive index | Capable | Capable | Capable | Capable |
| measurement | | | | |
| Comprehensive decision | Good | Good | Good | Good |

TABLE 3

| Item | | Example 15 | Example 16 | Example 17 | Example 18 |
|---|---|---|---|---|---|
| Average core Δ1 (%) | | 0.34 | 0.36 | 0.35 | 0.34 |
| Main-axis rotational frequency (rpm) | | 25 | 25 | 25 | 25 |
| Burner traverse speed (mm/min) | | 110 | 60 | 80 | 80 |
| Temperature during | max | 1010 | 970 | 980 | 970 |
| outside vapor deposition | min | 890 | 830 | 870 | 820 |
| (° C.) | | | | | |

| | | | | |
|---|---|---|---|---|
| Average bulk density (g/cm3) | 0.38 | 0.20 | 0.30 | 0.21 |
| Maximum bulk density among soot | 0.50 | 0.32 | 0.51 | 0.31 |
| layers (g/cm3) | | | | |
| Thickness of one soot layer (mm) | 0.43 | 0.70 | 0.52 | 0.49 |
| Variations of relative refractive index | −0.25~−0.28 | −0.25~−0.26 | −0.24~−0.26 | −0.24~−0.25 |
| difference Δ3 of trench portion (%) | | | | |
| Irregularity of refractive index profile | ±1.0 | ±0.3 | ±0.6 | ±0.4 |
| of trench portion (%) | | | | |
| Capability of refractive index | Capable | Capable | Capable | Capable |
| measurement | | | | |
| Comprehensive decision | Good | Good | Good | Good |

TABLE 4

| | Comparative | Comparative | Comparative | Comparative | Comparative | Comparative |
|---|---|---|---|---|---|---|
| Item | Example 1 | Example 2 | Example 3 | Example 4 | Example 5 | Example 6 |
| Average core Δ1 (%) | 0.34 | 0.35 | 0.34 | 0.35 | 0.34 | 0.40 |
| Main-axis rotational | 25 | 25 | 30 | 25 | 25 | 25 |
| frequency (rpm) | | | | | | |
| Burner traverse speed | 110 | 220 | 110 | 110 | 330 | 220 |
| (mm/min) | | | | | | |
| Temperature during | | | | | | |
| outside vapor | | | | | | |
| deposition (° C.) | | | | | | |
| max | 1040 | 1150 | 1030 | 1130 | 1140 | 1140 |
| min | 880 | 970 | 850 | 980 | 950 | 880 |
| Average bulk density | 0.42 | 0.55 | 0.41 | 0.56 | 0.56 | 0.42 |
| (g/cm3) | | | | | | |
| Maximum bulk | 0.53 | 0.65 | 0.53 | 0.65 | 0.61 | 0.61 |
| density among soot | | | | | | |
| layers (g/cm3) | | | | | | |
| Thickness of one | 0.45 | 0.22 | 0.43 | 0.46 | 0.12 | 0.23 |
| soot layer (mm) | | | | | | |
| Variations of relative | −0.23~−0.32 | −0.18~−0.25 | −0.23~−0.28 | −0.23~−0.31 | −0.17~−0.25 | −0.12~−0.24 |
| refractive index | | | | | | |
| difference Δ3 of | | | | | | |
| trench portion (%) | | | | | | |
| Irregularity of | ±2.5 | ±0.6 | ±1.5 | ±2.5 | ±0.2 | ±0.4 |
| refractive index | | | | | | |
| profile of trench | | | | | | |
| portion (%) | | | | | | |
| Capability of | Incapable | Capable | Incapable | Incapable | Capable | Capable |
| refractive index | | | | | | |
| measurement | | | | | | |
| Comprehensive | Poor | Poor | Poor | Poor | Poor | Poor |
| decision | | | | | | |

TABLE 5

| | | Comparative | Comparative | Comparative |
|---|---|---|---|---|
| Item | | Example 7 | Example 8 | Example 9 |
| Average core Δ1 (%) | | 0.33 | 0.35 | 0.35 |
| Main-axis rotational | | 25 | 25 | 25 |
| frequency (rpm) | | | | |
| Burner traverse speed | | 100 | 400 | 180 |
| (mm/min) | | | | |
| Temperature during | max | 1050 | 1150 | 880 |
| outside vapor | min | 900 | 980 | 730 |
| deposition (° C.) | | | | |

| | | | |
|---|---|---|---|
| Average bulk density (g/cm3) | 0.41 | 0.55 | 0.15 |
| Maximum bulk density among | 0.53 | 0.63 | 0.19 |
| soot layers (g/cm3) | | | |
| Thickness of one soot layer | 0.55 | 0.08 | 0.30 |
| (mm) | | | |
| Variations of relative | −0.25~−0.32 | −0.2~−0.32 | Not |
| refractive index difference | | | measured |
| Δ3 of trench portion (%) | | | |
| Irregularity of refractive index | ±3.2 | ±1.5 | Not |
| profile of trench portion (%) | | | measured |
| Capability of refractive index | Incapable | Incapable | Not |
| measurement | | | measured |
| Comprehensive decision | Poor | Poor | Poor |

According to Examples 1 and 2 and Comparative Example 1, even with substantially the same average bulk density (0.42 g/cm³), in the case of the thickness of one soot layer being as thick as 0.45 mm (Comparative Example 1), the irregularity of the refractive index profile of the second cladding portion was as large as ±2.5%. Due to the strong effect of striae in Comparative Example 1, refractive index profile measurement of the optical fiber preform could not be accurately performed. FIG. 5B shows the measurement result of the relative refractive index of the preform, which greatly varies from −0.23 to −0.32% in the radial direction of the optical fiber preform. As a result, the characteristic estimation in the optical fiber preform was difficult.

Since the thickness of one soot layer in Comparative Example 2 and Example 3 was as thin as 0.21 to 0.22 mm, the effect of striae was not seen, and thus refractive index measurement was possible for both. In Example 3, the average bulk density of the second cladding portion is 0.49 g/cm³, and the variations of the relative refractive index difference of the second cladding portion is small in both the radial direction and the longitudinal direction of the optical fiber preform, thereby showing good characteristic stability.

On the other hand, in the Comparative Example 2, since the average bulk density was as large as 0.55 g/cm³ during outside vapor deposition of the second cladding portion, it was not possible to disperse the fluorine to the vicinity of the center of the optical fiber preform. For that reason, the relative refractive index difference of the second cladding portion is −0.18% on the inner periphery side of the second cladding portion and −0.25% on the outer periphery side, and fluorine doping unevenness occurred in the radial direction.

In Comparative Example 3, by increasing the main-axis rotational frequency, the average bulk density was about the same compared to Comparative Example 1, but the thickness of one soot layer could be made as thin as 0.43 mm. However, the irregularity of the second cladding portion is ±1.5%, thus measurement of the refractive index profile could not be accurately carried out. Thereby, it was found that the irregularity of ±1.5% is insufficient for stabilizing the characteristics.

From the result of Comparative Example 1 and Comparative Example 4, it was found that the irregularity of the second cladding portion hardly improves just by lowering the average bulk density without changing the thickness of the one soot layer. That is to say, it was found that simply lowering the average bulk density is insufficient to improve the striae, and cannot contribute to characteristic stabilization of the optical fiber preform.

From the result of Example 4, if the thickness of one soot layer is 0.39 mm, the effect of the striae of the second cladding portion was small (irregularity ±1.2%), and it was possible to accurately measure the refractive index profile. Since the average bulk density is as low as 0.5 g/cm³, variations of the relative refractive index difference of the second cladding portion were small in both the radial direction and the longitudinal direction of the optical fiber preform, and thus it showed good characteristic stability.

From the result of Example 5, even if the average bulk density is made as low as 0.2 g/cm³, it was confirmed that manufacturing is possible without soot cracking. Additionally, with the thickness of one soot layer as thin as 0.1 mm, the striae can hardly be recognized (±0.2 by irregularity). As a result, the relative refractive index difference of the second cladding portion is −0.24% on the inner periphery side of the second cladding portion and −0.25% on the outer periphery side, and so the fluorine doping could also be made uniform.

Also, from the result of Comparative Example 5, in the case of the thickness per one layer being thin at 0.12 mm, hardly any striae was observed. However, since the average bulk density is large at 0.56 g/cm³, the fluorine does not diffuse to the center side of the porous silica body, leading to the result of the large variations of the relative refractive index difference of the second cladding portion. For this reason, the size of the second cladding portion was not as designed, and thereby deteriorating the characteristic of the bending loss.

In Example 6 to Example 10, the relative refractive index difference Δ₁ of the core region and the relative refractive index difference Δ₃ of the second cladding portion manufactured by outside vapor deposition are changed, but the same irregularity and variations of the relative refractive index difference Δ₃ are shown as those of Example 1, and all are good results. This reveals that by controlling the thickness of one soot layer and the average bulk density, it is possible to manufacture with a good yield an optical fiber preform that is uniformly doped with fluorine regardless of the relative refractive index difference Δ₁ of the core region and the relative refractive index difference Δ₃ of the second cladding portion.

Comparative Example 6 has the same conditions as Example 1 other than the surface temperature of the porous silica body being higher at the start of outside vapor deposition, and the maximum bulk density being greater. However, according to the measurement results of the refractive index profile, it was found that fluorine is not doped in the region to the inside of the second cladding portion. A possible cause of this is that due to the bulk density being greater, the fluorine-containing gas was hindered from diffusing into the interior of the porous silica body, and thus the reaction did not proceed. As a result, the variation amount of the relative refractive index difference Δ₃ of the second cladding portion increased, and degradation of the characteristics occurred.

In Example 11, the burner traverse speed is the same as in Example 2 at 165 mm/min, but since the surface temperature of the porous silica body during outside vapor deposition was lower, the average bulk density is low. Due to the average bulk density being low, the variations of the relative refractive index difference Δ₃ of the second cladding portion are small. Also, the irregularity of the refractive index of the second cladding portion is small at ±0.3%, and refractive index measurement could be performed without issue, and so the comprehensive decision is good.

The burner traverse speed in Example 12 is at 300 mm/min which is faster than in Examples 6 to 10, and the thickness of one soot layer is thinner. Therefore, the irregularity of the refractive index of the second cladding portion is low at ±0.4%, and the comprehensive decision is good.

In Example 13, the burner traverse speed is the same as in Examples 6 to 10, but the surface temperature of the porous silica body during outside vapor deposition is lower. For that reason, the average bulk density was low. As a result, the variations of the relative refractive index difference Δ₃ of the second cladding portion are small, and the irregularity of the refractive index of the second cladding portion is also small, and so the comprehensive decision is good.

In Example 14, the burner traverse speed is at 180 mm/min which is slower than in Examples 6 to 10, and so the thickness of one soot layer is thicker. However, the average bulk density is low at 0.35 g/cm³. For that reason, the variations of the relative refractive index difference Δ₃ of the second cladding portion and the irregularity of the refractive index of the second cladding portion are equivalent, and so the comprehensive decision is good.

In Example 15, the burner traverse speed is the same as in Comparative Examples 1 and 3, but the thickness of one soot layer is at least 0.4 mm. However, since the temperature during the outside vapor deposition is lower, the average bulk density is low at 0.38 g/cm³. As a result, the irregularity of the refractive index of the second cladding portion is restrained to ±1.0%. For that reason, refractive index measurement can be performed without problems, and so the comprehensive decision is good. It is clear from this, even if the thickness of one soot layer is 0.4 mm or more, the average bulk density should be 0.4 g/cm³ or less.

In Examples 16 to 18, by slowing down the burner traverse speed, each soot thickness is increased to 0.49 to 0.70 mm. In addition, by lowering the temperature during the outside vapor deposition, the average bulk density can be lowered to 0.20 to 0.30 g/cm³. As a result, the variations of the relative refractive index difference Δ₃ of the second cladding portion, and the irregularity of the refractive index of the second cladding portion can be held to a low level, and so a good result is obtained.

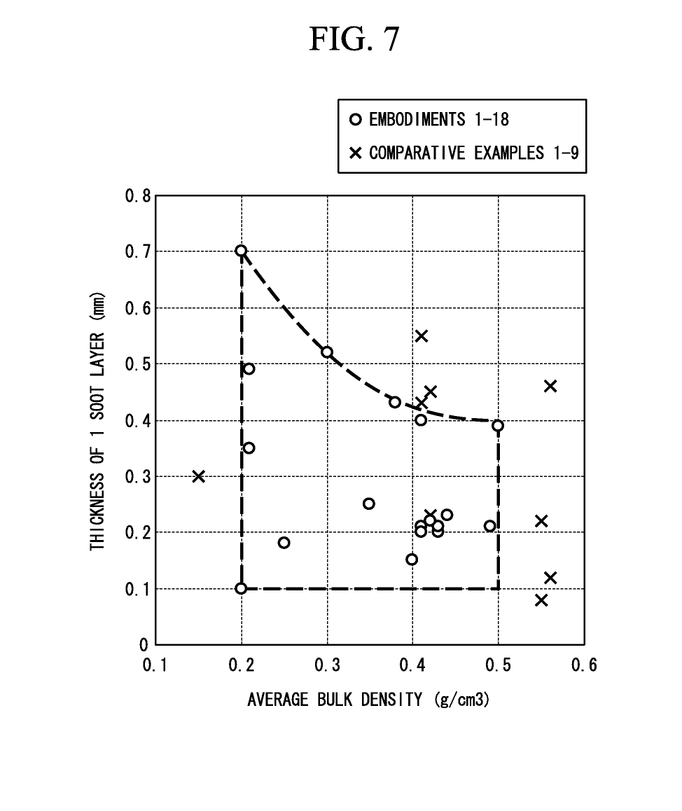

Table 6 summarizes the results of Examples 1 to 10 and Comparative Examples 1 to 6. Also, the results of all the examples and comparative examples are summarized in FIG. 7. According to Table 6 and FIG. 7, it is found that making the average value of the bulk density x (g/cm³)(the average bulk density that is the average of the bulk density of all soot layers that are included in the porous silica body) be in the range 0.2≦x≦0.5, and making the average deposition thickness y (mm) of a plurality of soot layers be in the range of 0.1≦y≦4.0x²−3.8x+1.3 (the range enclosed by the broken line in FIG. 7) is effective for obtaining a good result. In particular, by making the average bulk density x (g/cm³) be in the range of 0.2≦x≦0.5, and the thickness of one soot layer y (mm) be in the range of 0.1≦y≦0.4, it is possible to effectively perform soot layer deposition. It should be noted that, even within this range, since the variations of the relative refractive index difference of the second cladding portion increases when the maximum value of the bulk density in each soot layer is greater than 0.6 g/cm³ (Comparative Example 6), the maximum value of the bulk density must be 0.6 g/cm³ or less.

TABLE 6

| | | Thickness of one soot layer (mm) | | | |
|---|---|---|---|---|---|
| | | 0.10~1.12 | 0.20~0.23 | 0.39~0.40 | 0.43~0.46 |
| Average | 0.2 | Exam- | | | |
| bulk | | ple 5: | | | |
| density | | good | | | |
| (g/cm3) | 0.40~0.44 | | Example 1: | Exam- | Comparative |
| | | | good | ple 2: | example 1: |
| | | | Comparative | good | poor |
| | | | Example 6: | | Comparative |
| | | | poor | | example 3: |
| | | | Examples | | poor |
| | | | 6~10: good | | |
| | 0.49~0.50 | | Example 3: | Exam- | |
| | | | good | ple 4: | |
| | | | | good | |
| | 0.55~0.56 | Com- | Comparative | | Comparative |
| | | para- | example 2: | | example 4: |
| | | tive | poor | | poor |
| | | exam- | | | |
| | | ple 5: | | | |
| | | poor | | | |

As stated above, according to the porous silica body, the optical fiber preform, the manufacturing method of the porous silica body, and the manufacturing method of the optical fiber preform of the present embodiment, it is possible to uniformly and efficiently perform fluorine doping in a soot layer. Accordingly, if an optical fiber is manufactured by drawing this kind of optical fiber preform, it is possible to provide at a low cost the optical fiber as shown in FIG. 1 with low loss due to bending and having excellent connectivity with a general optical fiber for transmission.

According to the present invention, it is possible to uniformly and efficiently perform fluorine doping in a soot layer, and it is possible to provide an optical fiber with low loss due to bending and having excellent connectivity with a general optical fiber for transmission.

What is claimed is:

1. A manufacturing method for a porous silica body comprising:
a step of arranging a plurality of burners around an optical fiber core rod; and
a deposition step of depositing a plurality of soot layers on an outer peripheral surface of the optical fiber core rod by the burners, wherein
the deposition step comprises forming each of the plurality of soot layers by one of the burners, and depositing each soot layer to satisfy 0.2≦x≦0.5 and 0.1≦y≦4.0x²−3.8x+1.3 where x (g/cm³) is the average bulk density and y (mm) is the deposition thickness, and so that the maximum value of the bulk density of the soot layers becomes 0.6 g/cm³ or less.

2. The manufacturing method for a porous silica body according to claim 1, wherein
each soot layer is deposited so as to satisfy 0.2≦x≦0.5 and 0.1≦y≦0.4.

3. The manufacturing method for a porous silica body according to claim 1, wherein the optical fiber core rod is manufactured by vapor-phase axial deposition method.

4. A manufacturing method for an optical fiber preform, comprising dehydrating and sintering in a fluorine-containing gas a porous silica body manufactured by the manufacturing method according to claim 1.

5. A porous silica body comprising a plurality of soot layers deposited on an outer peripheral surface of an optical fiber core rod, wherein
the maximum value of a bulk density of the soot layers is 0.6 g/cm³ or less, and each soot layer satisfies 0.2≦x≦0.5 and 0.1≦y≦4.0x²−3.8x+1.3, when x (g/cm³) is an average bulk density and y (mm) is a deposition thickness.

6. The porous silica body according to claim 5, wherein each soot layer satisfies 0.2≦x≦0.5 and 0.1≦y≦0.4.

7. An optical fiber preform manufactured by dehydrating and sintering, in a fluorine-containing gas, the porous silica body according to claim 5.
